(19) United States
(12) Patent Application Publication
(10) Pub. No.: US 2006/0171074 A1
(43) Pub. Date: Aug. 3, 2006

(54) Shutter lock for use in a flexible data storage card

(76) Inventors: J. Arthur Wagner, San Jose, CA (US); Tu Nguyen, San Jose, CA (US); Ron Crain, San Jose, CA (US); William F. Witt, Palo Alto, CA (US); Greg Lyon, San Jose, CA (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/231,531

(22) Filed: Sep. 21, 2005

Related U.S. Application Data
(63) Continuation of application No. 11/067,499, filed on Feb. 25, 2005, now abandoned.
(60) Provisional application No. 60/547,708, filed on Feb. 25, 2004.

(51) Int. Cl. G11B 23/03

(52) U.S. Cl. 360/133

(57) ABSTRACT

A flexible data storage card and shutter lock is disclosed. The flexible data storage card includes a housing, a media disc, a shutter, and a shutter lock. The housing includes a card top coupled to a base to define an enclosed region, and an access window defined by the base and communicating with the enclosed region. The media disc is rotatably disposed within the enclosed region. The shutter is slidably disposed within the enclosed region and defines a shutter window selectively alignable with the access window. The shutter lock is disposed within the enclosed region and is selectively couplable with the shutter.

### CROSS-REFERENCE TO RELATED APPLICATION

The subject matter of this application claims priority under 35 U.S.C. §119(e) to the subject matter of U.S. Provisional Patent Application No. 60/547,708, filed Feb. 25, 2004, which is incorporated herein by reference.

### THE FIELD OF THE INVENTION

The present invention relates to flexible data storage cards. More particularly, it relates to a shutter lock for a flexible data storage card.

### BACKGROUND OF THE INVENTION

Data storage media have been used for decades in the computer, audio, and video fields. Data storage media continue to be employed for storing large volumes of information in a form suited for subsequent retrieval and use.

Data storage media are generally provided in one of two forms, long strands of magnetic tape and rotating discs. The rotating disc storage media are of two types: hard disc (HD) media and floppy disc (FD) media. Generally, HD media are maintained within a housing of a data storage device. For example, HD media are commonly maintained within a computer hard drive and accessed via an internal read/write device of the drive. In contrast, FD media are removable from, and interchangeable between, data storage devices. In this regard, FD media have the benefit of being transportable.

HD media typically comprise rigid discs formed of a metal substrate having a sputter deposition of a magnetic film. Deposition of the magnetic film in this manner permits a very high magnetic recording density to be achieved. During a read/write operation, the HD media are rotated at relatively high speeds (i.e., approximately 10,000 rpm) and “fly” over the read/write head in a non-contact manner.

FD media typically are composed of a plastic substrate, such as polyester, that is coated with a slurry of magnetic particles. The FD media can be coated on both sides to form “two-sided” media. In any regard, FD media operate at relatively low speeds (i.e., less than 1000 rpm) and the read/write head contacts the FD media. To facilitate good wear characteristics, the magnetic slurry contains a binder and a bulk lubricant along with the magnetic particles. Commonly, FD media are provided to users in an industry-accepted format, such as 3.5 inch floppy discs. While universally accepted, these formats are not convenient to handle and carry, have limited storage capacity, and do not provide durable protection for the FD media.

More recently, efforts have been made to provide a conveniently sized, robust storage media offering advantages of both the HD and FD media. In particular, a transportable data storage card having a form factor of approximately the size of a credit card has been developed that includes a flexible, one-sided data storage media in the form of a disc. Such a device is known as a “flexible data storage card” and has mechanical flexibility in both the longitudinal and transverse directions. A flexible data storage card available from StorCard, Inc., San Jose, Calif. under the trademark StorCard® is one example.

Generally, the StorCard® flexible data storage card consists of an outer shell or housing that maintains the flexible media disc. The housing normally includes a separate cover and a separate base that encloses the flexible media, fabric liners, and other components. The cover is known as a card top and is formed of a plastic laminate and includes an integrated circuit that monitors the flow of data into, and out of, the flexible data storage card. The base is a thin metallic structure that is laminated to the card top to form the housing. A window is provided on the base and includes a shutter that provides selective access to the flexible media disc by an external read/write head.

During use, the shutter is displaced to provide access to the rotating flexible media disc by the read/write head. In this regard, the shutter is slideably mounted inside the housing. When the shutter is in the open position, the shutter window and the access window align, thus exposing the media disc. When not in use, the shutter is shunted to a closed position. It is possible, however, that taps or bumps to the housing may cause the shutter to be jostled to the open position. The inadvertent opening of the shutter may give rise to a risk of dust and debris entering into the housing, thus mitigating the protective purpose of the shutter. Debris present on the media disc has the potential to cause read/write errors and other failures. In addition, the build-up of debris in and near the shutter mechanism can interfere with the sliding of the shutter.

Flexible data storage cards offer high capacity memory storage in a flexible and transportable format. The popularity of flexible data storage cards is ever increasing. However, shutters that open inadvertently can be a conduit for dust and debris to the media disc, and may possibly decrease the useful life of the storage card. Accordingly, a need exists for a flexible data storage card having an improved shutter mechanism.

### SUMMARY OF THE INVENTION

One aspect of the present invention relates to a shutter assembly for use in a flexible data storage card. The shutter assembly includes a shutter layer defining a trace, a shutter slidably disposed within the trace, and a magnetically responsive shutter lock coupled to the shutter layer. In this regard, the shutter lock is selectively couplable with the shutter between an engaged state and a disengaged state.

Yet another aspect of the present invention relates to a method of restricting lateral movement of a shutter disposed in a flexible data storage card. The method includes forming a detent on the shutter, and providing a shutter lock including a pawl disposed in the flexible data storage card. The method additionally includes selectively engaging the pawl of the shutter lock with the detent of the shutter.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective, exploded view of a flexible data storage card including a shutter assembly according to one embodiment of the present invention;

FIG. 2 is a top plan view of a shutter of the shutter assembly shown in FIG. 1 according to one embodiment of the present invention;

FIG. 3 is a top plan view of a shutter lock of the shutter assembly shown in FIG. 1 according to one embodiment of the present invention;

FIG. 4 is a top plan view of the shutter assembly showing the shutter lock engaged with the shutter according to one embodiment of the present invention; and

FIG. 5 is a top plan view of the shutter assembly in the presence of a magnetic field and showing the shutter lock disengaged with the shutter according to one embodiment of the present invention.

### DETAILED DESCRIPTION OF THE PREFERRED EMBODIMENTS

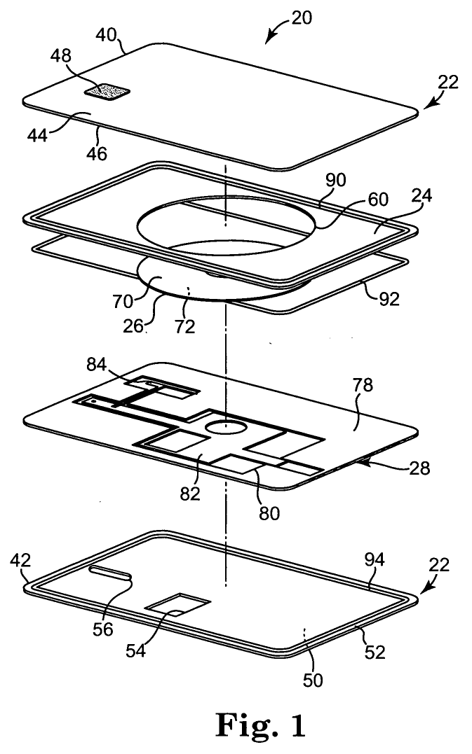

A simplified exploded, perspective view of a flexible data storage card that is representative of data storage cards advertised under the trademark StorCard® and according to one embodiment of the present invention is illustrated at 20 in FIG. 1. The flexible data storage card 20 includes a housing 22, a media layer 24, a flexible media disc 26, and a shutter assembly 28.

The housing 22 is sized to be transportable and has a form factor that approximates the size of a credit card. Thus, the housing 22 has a size of approximately 86 mm×54 mm×0.8 mm, although other dimensions are also acceptable. With this in mind, a card top 40 and a base 42 combine to define the housing 22. In one embodiment, the card top 40 forms a cover and the base 42 forms a bottom. However, as used though out the specification, directional terminology such as “cover,” “base,” “upper,” “lower,” “top,” “bottom,” etc., is employed for purposes of illustration only and is in no way intended to be limiting.

The card top 40 and the base 42 are reciprocally mated to one another and are generally rectangular. The card top 40 defines an exterior surface 44 and an interior surface 46. In one embodiment, an electronic chip 48 is mounted to the exterior surface 44 of the card top 40 and controls the flow of data to and from the media disc 26.

The card top 40 is generally flexible. In one embodiment, the card top 40 is a thin laminate of plastic and metal layers. In another embodiment, the card top 40 and the base 42 are each formed from a single, thin metallic layer. As an example, in one embodiment the card top 40 and the base 42 are each formed from a single metallic layer having a thickness of about 0.003 inch, such that when assembled, the housing 22 is flexible. After assembly, the flexible data storage card 20 is transportable, and can be, for example, carried in a wallet and flexed in both the transverse and longitudinal directions without damaging the flexible media disc 26.

The base 42 defines an exterior surface 50 and an interior surface 52. In addition, the base 42 defines an access window 54 and a shutter pin slot 56. The access window 54 is configured to permit access by a read/write head (not shown) to the flexible media disc 26. The shutter pin slot 56 is configured for access by a drive pin (not shown) of a drive (not shown) during a read/write process, as more fully described below.

The media layer 24 is generally a single layer of flexible material and defines a circular hole 60 configured to receive the flexible media disc 26. In this regard, the media layer 24 retains the flexible media disc 26 in a desired orientation within the housing 22 and forms an offset between the shutter assembly 28 and the card top 40.

The flexible media disc 26 (hereinafter media disc 26) is of a type known in the art and generally includes a thin sheet of polyester or similar material having a non-media side 70 opposite a media side 72. In this regard, in one embodiment the media side 72 is coated with a magnetic layer configured to magnetically record and store information. In general, the non-media side 70 is not coated with a magnetic layer, although the non-media side 70 can include one or more other coatings (i.e., a lubricating layer and/or and anti-static layer). For example, in one embodiment the media disc 26 is a thin sheet of polyester approximately 0.003 inch thick and includes a slurry-coated layer of magnetic particles on the media side 72.

The shutter assembly 28 includes a shutter layer 78 that defines a trace 80 (i.e., a cutout), a shutter 82, and a shutter lock 84. The shutter layer 78 is generally a flexible layer, and in one embodiment is a single layer of thin metal. In another embodiment, the shutter layer 78 is a flexible laminate of metal and/or plastic layers. In any regard, the shutter layer 78 defines the trace 80 that is otherwise a cutout formed in the shutter layer 78 sized and configured to receive the shutter 82 and the shutter lock 84. To this end, the shutter 82 is slidably retained within the trace 80, and the shutter lock 84 is cantilevered from the shutter layer 78 and oriented to selectively couple with the shutter 82 between an engaged state and a disengaged state. In one embodiment, the shutter lock 84 is cantilevered from the shutter layer 78 at a perimeter of the trace 80, as described below.

In addition, the flexible data storage card 20 includes adhesive layers configured to assemble the various components described above into a unitary flexible data storage card 20. In particular, first adhesive layer 90 is disposed between the media layer 24 and the interior surface 46 of the card top 40. A second adhesive layer 92 is disposed between the media layer 24 and the shutter assembly 28. A third adhesive layer 94 is disposed between the shutter assembly 28 and the inner surface 52 of the base 42. In one embodiment, each of the adhesive layers 90, 92, and 94 defines a gasket-like spacer that provides a clearance within the assembled housing 22 for movement of the rotatable media disc 26 and the slidable shutter 82.

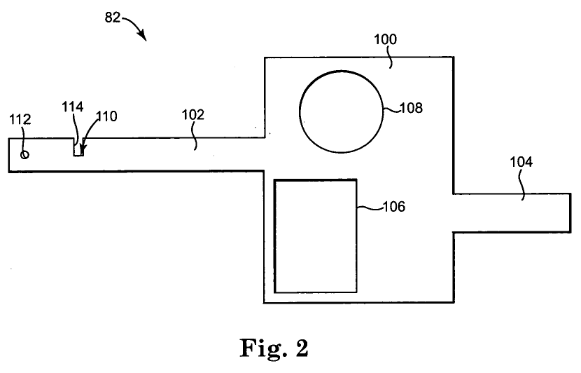

FIG. 2 is a top plan view of the shutter 82. The shutter 82 includes a shutter body 100, a shutter arm 102 extending from the shutter body 100, and a shutter leg 104 extending from the shutter body 100 opposite the shutter arm 102.

The shutter body 100 defines a shutter window 106 and a hub window 108. The shutter window 106 is sized for alignment with the access window 54 (FIG. 1) when the shutter 82 is disengaged from the shutter lock 84 (FIG. 1) and activated to an open position by a drive (not shown).

The shutter arm 102 extends from the shutter body 100 and defines a detent 110 and a pin aperture 112. The detent 110 is preferably formed as a part of the shutter arm 102, although the detent 110 could be defined by the shutter body 100 or by the shutter leg 104. In any regard, the detent 110 defines at least one engagement surface 114 configured to engage with the shutter lock 84 (FIG. 1) and impede lateral movement of the shutter 82, thus maintaining the shutter 82 in the closed position. The term detent is employed in this detailed description to include any surface suited for being a latching and/or engagement surface. With this in mind, the term detent includes cavities (i.e., slots or depressions), or protrusions (i.e., peaks) defined in the shutter 82, and preferably defined by the shutter arm 102. The pin aperture 112 is generally a circular hole defined in the shutter 82, and preferably defined by the shutter arm 102. A drive pin (not shown) of the drive (not shown) inserts into the pin aperture 112 in activating the disengaged shutter 82 to the open position.

The shutter leg 104 extends from the shutter body 100 opposite the shutter arm 102 and is configured to slide within the trace 80 (FIG. 1) in guiding and balancing the shutter 82 between the open and closed positions. In one embodiment, the mass of the shutter leg 104 counterbalances any force acting on the engagement surface 114 and/or the shutter arm 102 when the shutter lock 84 (FIG. 1) couples into the detent 110. In other words, in one embodiment the shutter leg 104 stabilizes the shutter 82 by balancing moment forces as the shutter lock 84 couples with the shutter 82 between the engaged and disengaged states.

The shutter 82 is generally formed of a thin and flexible material that is unaffected by magnetic forces. In one embodiment, the shutter 82 is formed of a single layer of metal approximately 0.004 inch thick. In another embodiment, the shutter 82 is formed of plastic. In any regard, in a preferred embodiment the shutter 82 is formed of material having a low magnetic permeability such that the shutter 82 is relatively unresponsive to magnetic field forces. For example, in one embodiment the shutter 82 is formed of a stainless steel having a relative magnetic permeability of less than 50, and preferably, the shutter 82 is formed of a 316 stainless steel having a relative magnetic permeability of approximately 10. In this regard, the relative magnetic permeability is defined to be a ratio of the magnetic permeability of the material (often expressed in units of Newtons per ampere squared) to the magnetic permeability of air (often expressed in units of Newtons per ampere squared), such that the relative permeability is a dimensionless number.

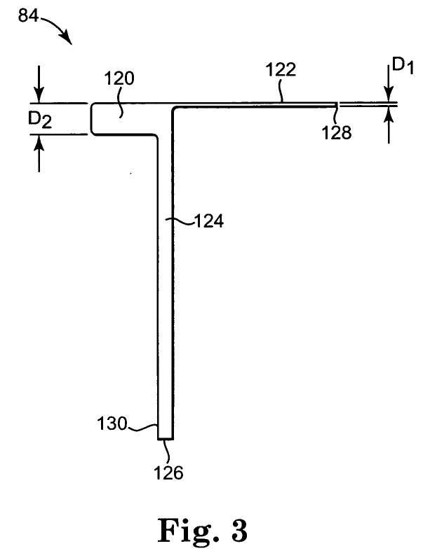

FIG. 3 is a top plan view of the shutter lock 84 according to one embodiment of the present invention. The shutter lock 84 includes a base 120, a lever 122 extending from the base and terminating in an end 128, and a leg 124 extending from the base 120 and terminating in a pawl 126. In one embodiment, the lever 122 extends from the base 120 in the range of 0.25 inch to 1.0 inch, preferably the lever 122 extends from the base 120 by approximately 0.5 inch; and the leg 124 extends from the base 120 in the range of 0.5 inch to 1.5 inch, preferably the leg 124 extends from the base 120 a length of approximately 0.75 inch.

The lever 122 is generally formed to have a low inertia such that the lever 122 will deflect in the presence of a magnetic field. In this regard, in one embodiment the lever 122 defines a leaf spring having a width D1 of between 0.005 inches to 0.02 inches, and preferably the lever 122 has a width D1 of approximately 0.008 inches, although other dimensions are also acceptable.

The base 120 is generally much more massive than the lever 122, and thus the base 120 has greater inertia than the lever 122. In one embodiment, the base 120 defines a width D2 of between 0.05 inches to 0.10 inches, and preferably the base 120 has a width D2 of approximately 0.08 inches, although other dimensions are also acceptable. In this manner, the base 120 is approximately an order of magnitude more massive than the lever 122.

The pawl 126 is disposed on an end of the leg 124 opposite the base 120. The pawl 126 defines at least one engagement surface 130 configured to lock (i.e., engage) with the engagement surface 114 defined by the detent 110 (FIG. 2). In one embodiment, a cross-section of the pawl 126 defines a generally rectangular plan form. In an alternate embodiment, a cross-section of the pawl 126 defines a generally triangular plan form.

The shutter lock 84 is preferably formed of a single layer of metal having a thickness of approximately 0.004 inches and a high magnetic permeability. In a preferred embodiment, the shutter lock 84 is formed of soft steel having a relative magnetic permeability of greater than 300. In one embodiment, the shutter lock 84 is formed of 1095 spring steel having a relative magnetic permeability of approximately 1000. With this in mind, in one embodiment, the relative magnetic permeability of the shutter lock 84 is at least one order of magnitude (i.e., ten times) greater than the relative magnetic permeability of the shutter 82 (FIG. 2), and more preferably, the relative magnetic permeability of the shutter lock 84 is at least two orders of magnitude (i.e., one-hundred times) greater than the relative magnetic permeability of the shutter 82. With this in mind, the shutter lock 84 is generally responsive to (i.e., movable by) magnetic fields, whereas the shutter 82 is not responsive to magnetic fields.

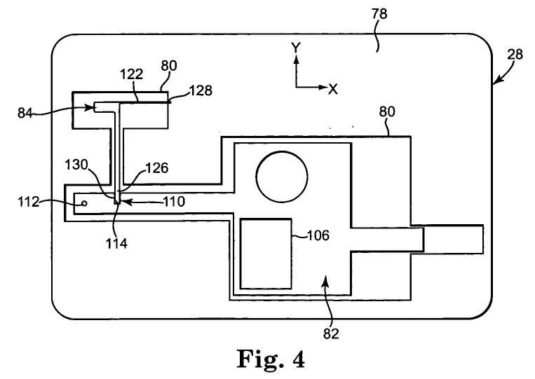

FIG. 4 is a top plan view of the shutter assembly 28 showing the shutter 82 slidably retained within the trace 80 of the shutter layer 78 and engaged by the shutter lock 84. For ease of illustration and descriptive clarity, the shutter assembly 28 will be discussed apart from the other components of the flexible data storage card 20 (FIG. 1), although one of skill in the art of flexible data cards will understand that the following description is consistent with a shutter assembly 28 in an assembled flexible data storage card 20.

As a point of reference, the shutter 82 is in a closed position relative to the shutter layer 78 such that the media disc 26 (FIG. 1) is not exposed to the access window 54 (FIG. 1). In other words, the shutter window 106 is not aligned with the access window 54. The shutter lock 84 is disposed within the trace 80 and is cantilevered from the shutter layer 78 at a perimeter of the trace 80. In particular, the end 128 of the lever 122 is coupled to the shutter layer 78 at a perimeter of the trace 80. In this manner, the end 128 is essentially fixed in place relative to the shutter layer 78 thereby confining the lever 122 (and also the shutter lock 84) within the trace 80, such that movement of the pawl 126 is restricted to one direction (vertically in the Y-direction relative to FIG. 4). In addition, the shutter 82 is slidably retained within the trace 80 and restricted to lateral movement (horizontally in the X-direction relative to FIG. 4) along a longitudinal axis of the shutter 82. Further, the pawl 126 is engaged with the detent 110, such that the engagement surface 130 of the pawl 126 nests with the engagement surface 114 of the detent 110. In this manner, the shutter 82 is impeded from sliding within the trace 80 such that lateral movement of the shutter 82 is restricted or completely eliminated.

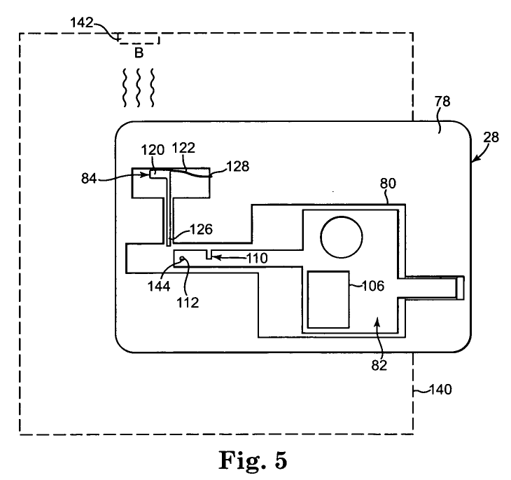

FIG. 5 is a simplified schematic view of the shutter assembly 28 as inserted in a drive 140 according to one embodiment of the present invention. While one of skill in the art of flexible storage cards will understand that the entire flexible data storage card 20 (FIG. 1) is actually inserted into the drive 140, a full appreciation of the present invention can be gathered with reference to the interaction between the shutter assembly 28 and the drive 140, as depicted in FIG. 5. Therefore, the shutter assembly 28 will be discussed apart from the other components of the flexible data storage card 20, in a manner similar to the description presented for FIG. 4 above. With this in mind, the drive 140 includes a magnetic field source 142 and a drive pin 144. The magnetic field source 142 emanates a magnetic field B, and the drive pin 144 is coupled to the pin aperture 112 of the shutter 82 upon insertion of the data storage card 20 into the drive 140.

The shutter 82 is illustrated in FIG. 5 in an open position. In one exemplary embodiment, as the flexible data storage card 20 (FIG. 1) is inserted into the drive 140 for read/write purposes, the magnetic field source 142 causes the shutter lock 84 to move to a disengaged state relative to the shutter 82. In particular, the magnetic field B acts upon the magnetically permeable shutter lock 84 and attracts the shutter lock 84 to the source 142. Specifically, the pawl 126 deflects in the Y-direction (shown in FIG. 4), disengaging from the detent 110, as the lever 122 deflects, thus ensuring essentially linear movement of the pawl 126. Simultaneously, the drive pin 144 physically couples with the pin aperture 112 via the shutter pin slot 56 (FIG. 1). Thereafter, the drive pin 144 displaces the disengaged shutter 82 to the open position (as shown). In this manner, the shutter lock 84 can be selectively and magnetically activated between an engaged state (FIG. 4) and a disengaged state (FIG. 5) in facilitating movement of the shutter 82 between the closed position (FIG. 4) and the open position (FIG. 5).

The magnetic field B can be any magnetic field, for example an electro-magnetic field or a magnetic field created by a permanent magnet. In one embodiment, the magnetic field source 142 can be switched on and off. With this in mind, in the absence of the magnetic field B, the shutter lock 84 occupies a zeroth energy state (i.e., the shutter lock 84 is not deflected) and is engaged with the shutter 82. In contrast, when the magnetic field B is present (or “on”), the shutter lock 84 responds to the magnetic field B and the pawl 126 is displaced away from the detent *110, thus permitting lateral movement of the shutter 82 within the trace 80.

In one embodiment, the magnetic field source 142 is a permanent magnet disposed in a card reader, such as a StorPod® brand reader available from StorCard, Inc., San Jose, Calif. In one embodiment, the magnetic field source 142 activates the shutter lock 84 to the disengaged state whenever the flexible data storage card 20 (FIG. 1) is inserted into the drive 140, for example, the StorPod® brand reader. Consequently, removal of the flexible data storage card 20 from the drive 140 returns the shutter 82 to the closed position and interrupts the effect of the magnetic field B on the shutter lock 84 such that the shutter lock 84 returns to reside in the stable zeroth energy state (i.e., the shutter lock 84 engages with the shutter 82).

Magnetic fields B of large magnitude can potentially interfere with data stored on the media disc 26 (FIG. 1). For this reason, it is desired that the magnetic field B employed to activate the shutter lock 84 be of a magnitude that is incapable of writing over the data stored on the media disc 26. In this regard, it is preferred that the shutter lock 84 be responsive to magnetic fields B of relatively small magnitude (i.e., that the shutter lock 84 have a high relative magnetic permeability), and that the shutter 82 be relatively unresponsive to magnetic fields B of relatively small magnitude (i.e., that the shutter 82 have a low relative magnetic permeability). As described above, therefore, in one embodiment the relative magnetic permeability of the shutter lock 84 is at least ten times greater than the relative magnetic permeability of the shutter 82, and preferably, the relative magnetic permeability of the shutter lock 84 is at least two orders of magnitude (i.e., one-hundred times) greater than the relative magnetic permeability of the shutter 82.

Although specific embodiments have been illustrated and described for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a variety of embodiments. This application is intended to cover any adaptations or variations of the embodiments discussed herein. Therefore, it is intended that this invention be limited only by the appended claims and their equivalents.

What is claimed is:

1. A shutter assembly for use in a flexible data storage card comprising:
a shutter layer defining a trace;
a shutter slidably disposed within the trace; and
a magnetically responsive shutter lock coupled to the shutter layer;
wherein the shutter lock is selectively couplable with the shutter between an engaged state and a disengaged state.

2. The shutter assembly of claim 1, wherein the shutter lock defines:
a body; and
a leaf spring extending from the body;
wherein an end of the leaf spring is coupled to the shutter layer.

3. The shutter assembly of claim 1, wherein the shutter is slidable within the trace in a first direction, and a pawl of the magnetically responsive shutter lock is movable in a second direction generally orthogonal to the first direction.

4. A method of restricting lateral movement of a shutter disposed in a flexible data storage card, the method comprising:
forming a detent on the shutter;
providing a shutter lock including a pawl disposed in the flexible data storage card; and
selectively engaging the pawl of the shutter lock with the detent of the shutter.

5. The method of claim 4, wherein providing a shutter lock includes providing a magnetically responsive shutter lock formed of metal and having a relative magnetic permeability of greater than approximately 300.

6. The method of claim 4, wherein selectively engaging the pawl includes cantilevering a leaf spring of the shutter lock to a shutter layer disposed within the flexible data storage card, and further wherein the shutter layer and the cantilevered leaf spring restrict movement of the pawl to a direction generally orthogonal to a longitudinal axis of the shutter.

7. The method of claim 4, wherein selectively engaging the pawl includes magnetically causing the pawl to move between an engaged state and a disengaged state relative to the detent of the shutter.

8. The method of claim 7, wherein in the engaged state the shutter lock restricts lateral movement of the shutter, and in the disengaged state the shutter is movable.

9. The method of claim 7, wherein magnetically activating the pawl includes inserting the flexible data storage card into a drive having a magnetic field source.

10. The method of claim 4, further comprising:
inserting the flexible data storage card into a drive having a magnetic field source and a drive pin;
magnetically disengaging the pawl of the shutter lock from the detent of the shutter;
coupling the drive pin into a pin aperture defined by the shutter; and
moving the shutter to an open position.
